(19) United States
(12) Patent Application Publication
(10) Pub. No.: US 2008/0270159 A1
(43) Pub. Date: Oct. 30, 2008

(54) Dynamically determining products for a customer based on the customer's requirements

(76) Inventors: Randi E. Constable, Cupertino, CA (US); Mark Welke, Cupertino, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/799,428

(22) Filed: Apr. 30, 2007

(51) Int. Cl. G06Q 30/00

(52) U.S. Cl. 705/1

(57) ABSTRACT

Embodiments of the present invention pertain to dynamically determining products for a customer based on the customer's requirements. According to one embodiment, information describing customers' requirements is received. A data structure is dynamically created based on the information. The data structure includes a plurality of decision trees for types of products. Automatic determination of a particular solution is enabled based on the data structure and requirements for a particular customer. The automatic determination uses a first decision tree for a first type of product and a second decision tree for a second type of product to determine what products to associate with the particular solution.

### TECHNICAL FIELD

Embodiments of the present invention relate to determining products. More specifically, embodiments of the present invention relate to dynamically determining products for a customer based on the customer's requirements.

### BACKGROUND

Various companies buy different types of products in order to operate. For example, companies buy computers, operating systems, storage, various types of software, and printers, among other things. As a part of determining what products they need to operate, these companies communicate their requirements to sales, marketing, and consulting people that work for companies that sell the products. For the purposes of this application, the term “marketing” shall include, among other things, sales, marketing, or consulting, or a combination thereof.

The marketing people attend training meetings to learn about the products their company sells so that they can help their customers determine what their requirements are. For example, these teams of people can attend training meetings to learn about the computers, the operating systems, the different types of storage, the various types of software and printers that their company sells. The marketing people can use what they learned from the training meetings to help their customers determine what solution is needed to best meet their customers' business objectives. Once a customer's business objectives have been determined, the products are identified that meet the customer's needs.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 is a block diagram of a data structure for dynamically determining a product solution based on a customer's requirements, according to one embodiment.

FIG. 2 depicts an example of a part of a decision tree, according to one embodiment.

FIG. 3 is a block diagram of a system for dynamically determining products for a customer based on the customer's requirements, according to one embodiment.

FIG. 4 depicts a flowchart for a method of dynamically determining a product solution for a customer based on the customer's requirements, according to one embodiment.

The drawings referred to in this description should not be understood as being drawn to scale except if specifically noted.

### BEST MODE FOR CARRYING OUT THE INVENTION

Reference will now be made in detail to various embodiments of the invention, examples of which are illustrated in the accompanying drawings. While the invention will be described in conjunction with these embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following description of various embodiments of the present invention, numerous specific details are set forth in order to provide a thorough understanding of the present invention. In other instances, well-known methods, procedures, components, and circuits have not been described in detail as not to unnecessarily obscure aspects of the present invention.

### Overview

Marketing people often have difficulties determining what products to recommend to customers to achieve a comprehensive solution. Often times dependencies and compatibility issues can be confusing or overlooked or misinterpreted. Marketing people are typically assigned to sell and implement a particular type of product and they are frequently only trained to understand their respective type of product. For example, one team of marketing people sells operating systems and another team sells storage and another sells high availability software and yet another sells management software. Various products have become very complex and there are interdependencies between the different types of products. For example, a high availability solution that a customer wants may only support certain storage, operating system and even processor type. However, due to the complexity of the products and the interdependencies between the products, this has turned into an extremely difficult task for the marketing teams. Additionally, the customer may also want to consider how their solution will be managed. According to one embodiment, this may all be covered in the initial sale and implementation to provide a comprehensive solution and total customer satisfaction.

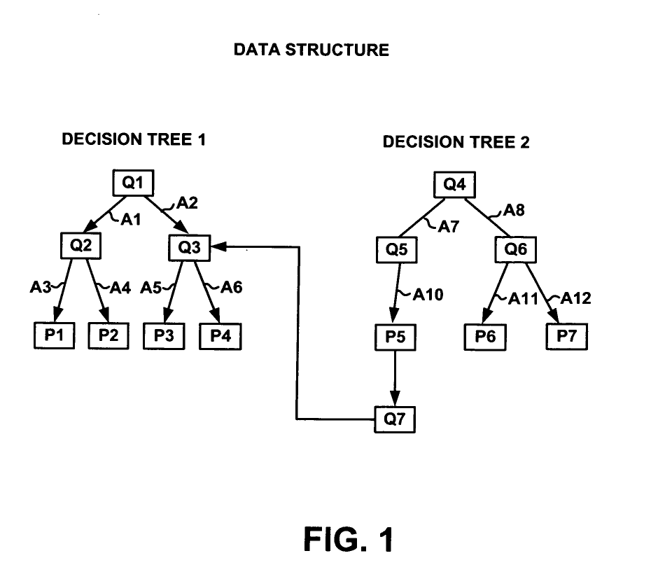

According to various embodiments, a product solution is dynamically determined for a customer based on the customer's business requirements. FIG. 1 is a block diagram of a data structure for dynamically determining a product solution based on a customer's business requirements, according to one embodiment. The data structure includes a plurality of decision trees 1 and 2. The decision trees each correlate to a type of product. For example a decision tree can correlate to operating systems, storage, virtualization, printers and so on. The decision trees represent questions Q1-Q7 and answers A1-A12 to those questions Q1-Q7 for determining various customers' requirements for a type of product. A particular solution can be determined based on a line of questions and answers for a particular customer. For example, if the customer provides answer A2 to question Q1 and answer A5 to question Q3, then the particular solution for that customer would include product P3. According to one embodiment, the term “product” shall be used to refer to one or more products, one or more categories of products, or a bundle of products, among other things. A bundle of products may be a set of product categories.

A customer's requirements frequently involve more than one type of product. For example assume that a customer wants their data to be highly available. As a part of answering questions pertaining to storage to provide high availability, it may be determined that the customer also needs different operating systems. For example, assume that decision tree 1 pertains to storage and decision tree 2 pertains to operating systems. Assume it is determined that product P5 is well suited for a particular customer however product P5 depends on a certain type of operating system. The customer may be asked question Q7 and if they answer A9, the line of questioning moves to the decision tree 1 pertaining to operating systems.

### Information Describing Various Customers' Requirements

According to one embodiment, information describing various customers' requirements is received and used to dynamically create a data structure as depicted in FIG. 1. Table 1 depicts information describing various customers' requirements, according to one embodiment.

TABLE 1
exemplary information describing various customers' requirements.

| Row | Pieces of information describing |
|---|---|
| No. | various customers' requirements |
| 1 | Q1->A1->Q2 |
| 2 | Q2->A3->P1 |
| 3 | Q2->A4->P2 |
| 4 | P5->Q7 |
| 5 | Q7->A9->Q3 |
| 6 | Q3->A5->P3 |
| 7 | Q3->A6->P4 |

Table 1 depicts a subset of information that can be used for creating a part of the data structure as depicted in FIG. 1. For example row 1 indicates that answer A1 to question Q1 results in question Q2 being asked. Row 2 indicates that answer A3 to question Q2 results in a solution that includes product P1 being recommended to the customer. Rows 4, 5 and 6 indicate that the customer would be recommended a solution that includes products P5 and P3. Rows 4, 6 and 7 indicate the customer would be recommended a solution that includes products P5 and P4. According to one embodiment, the information describing various customers' requirements is stored in a database.

### Decision Trees and User Interface

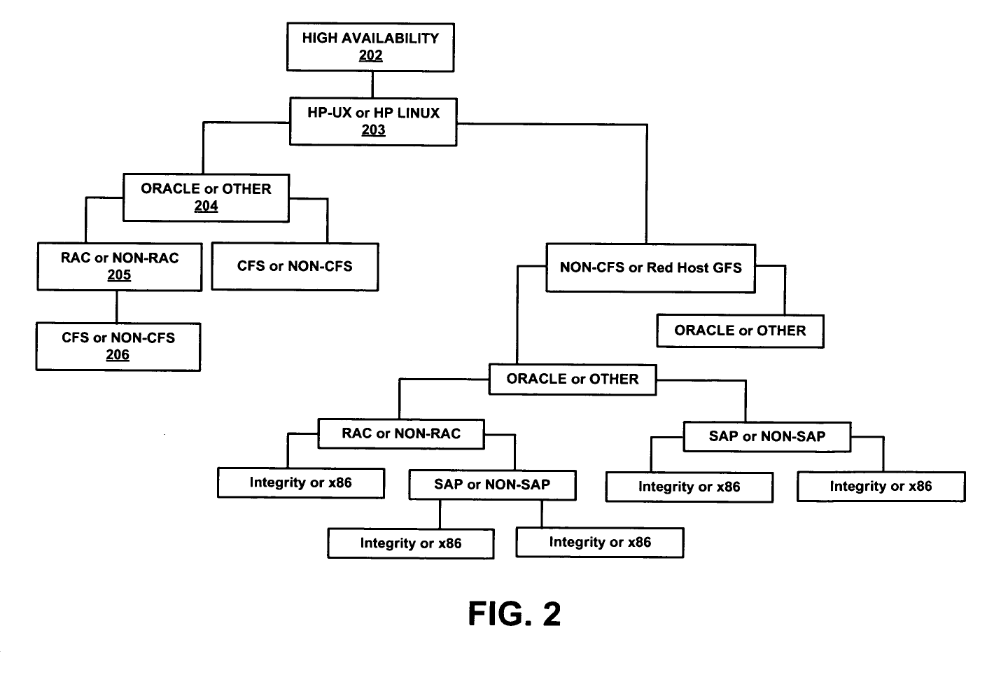

FIG. 2 depicts an example of a part of a decision tree, according to one embodiment. A question is associated with each of the blocks. As indicated by the highest level block 202, the partial decision tree depicted in FIG. 2 pertains to high availability types of products. If the answer to the question “high availability?” associated with block 202 is yes, then processing proceeds to 203.

The questions associated with the other blocks are presented in terms of choosing between two options. For example, the questions are “A or B?” If option A is chosen, processing proceeds to the left. If option B is chosen, processing proceeds to the right. For the purposes of illustration, assume that option Hewlett Packard's Unix™ (HP-UX™) is selected for block 203, Oracle™ is selected for block 204, Real Application Cluster™ (RAC™) is selected for block 205, and Cluster File System™ (CFS™) is selected for block 206. In this case, a minimum solution that includes a product bundle that pertains to T2777xx HP Serviceguard Cluster File System for RAC and T2797xx Mission Critical OE with Serviceguard Cluster File System for RAC as depicted in Table 2 may be displayed.

TABLE 2
An example of a minimum solution, according to one embodiment.

HP Serviceguard
HPServiceguard Extension for RAC
HP Serviceguard Manager
HP Enterprise Cluster Master Toolkit
VERITAS File System (VxFS)
VERITAS Volume Manager (VxVM)
Cluster File System/Cluster Volume Manager
Dynamic Storage Tiering (DST)
Instant Volume Snapshots
Checkpoint Restore
Oracle Disk Manager
Storage Mapping to LUN Level
Storage Rollback
Storage Checkpoint
Disk Group Split and Join
Fast Mirror Resync
VERITAS Enterprise Administrator (GUI)
Dynamic Multi-Pathing
Intelligent Storage Provisioning
Configuration Backup
Storage Expert
History Log
Online Intent Log Resize
Named Data Streams
Online LUN Resize
Portable Data Containers
Hardware Assisted E-Copy
Multi-Volume File System
Online Administration

Additional products may also be considered for T2777xx, such as T2786AC-HP Virtual Server Environment™ (VSE), T2803xx-HPServiceguard Extension for Systems Applications and Products™ (SAP™), T2797xx HP Mission Critical OE™ with Serviceguard Cluster File System™ for RAC™, 85140xx—HP Serviceguard Network File System (NFS) Toolkit™, and SGDTOOLBOX-HP Serviceguard Developer's Toolbox™. As a part of considering one of the products, processing may proceed to another decision tree. For example, processing may proceed to a decision tree that pertains to virtualization as a part of determining whether to include T2786AC-HP Virtual Server Environment™ (VSE) in the solution.

Examples of types of decision trees can pertain to, among other things, operating systems, storage, processors, manageability, printers, virtualization, and so on. Products associated with HP Openview™ are an example of products related to manageability. A type of product may be a subset of one or more other types of product. For example, high availability may pertain to storage that provides mirroring or duplexing and software that interoperates with that storage to provide high availability, among other things. In another example, virtualization may include a subset of operating systems that provide virtual machines.

FIG. 2 depicts a part of a decision tree that pertains to high availability. In another example a decision tree may pertain to enterprise operating environments. Under enterprise operating environments, a customer may be asked if they are interested in HP UX™, Linux, or an IBM™ solution. If the customer specifies HP UX™ the customer may be asked whether they have or need 2, 4, or 8 processors. Other leading questions relative to the customer's answer may be asked with the intention of obtaining more information to build a proper solution.

FIG. 2 depicts various questions using acronyms of various products. The full name of all of the acronyms have been described herein except for Integrity and X86. Integrity refers to an Itanium™ processor box, which is a category of HP™ servers based on the Itanium processor, and x86 is a category of Intel™ processors that use an x86 chip.

FIG. 1 depicts control proceeding from decision tree 2 to decision tree 1 using question 7 after product P5. However, control between decision trees can be implemented in other ways. For example, an answer that results from question A5 could cause processing to switch from decision tree 2 to decision tree 1.

A user interface of menus can be used to present the questions to a user. A menu can also display a solution or a part of a solution as depicted in Table 2. The user interface is generated based on a decision tree, according to one embodiment. The user interface may be automatically generated.

### Configurator

According to one embodiment, a configurator uses the solution or a derivative of the solution to determine how to configure a customer's environment. For example, the configurator may use the solution to determine a proposal, an invoice, part numbers, or an order, or a combination thereof. An example of a configurator is HP™'s Conrad/Watson™.

### A System for Dynamically Determining Products for a Customer Based on the Customer's Requirements

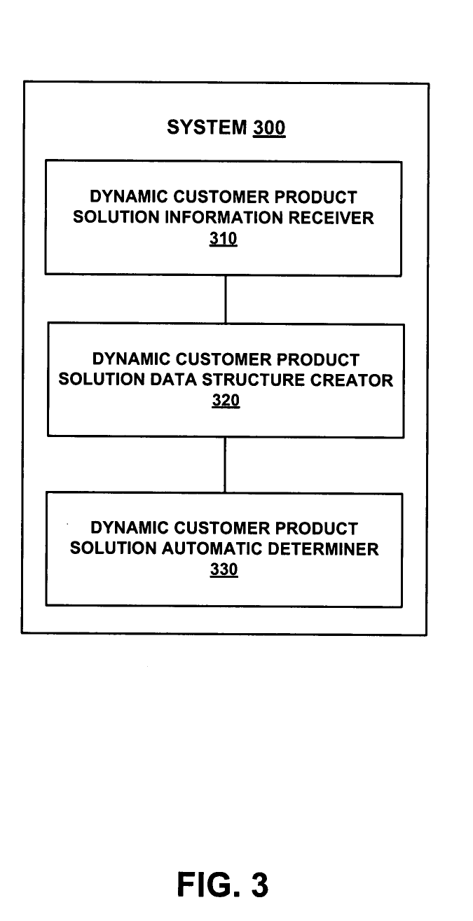

FIG. 3 is a block diagram of a system for dynamically determining products for a customer based on the customer's requirements, according to one embodiment. The blocks that represent features in FIG. 3 can be arranged differently than as illustrated, and can implement additional or fewer features than what are described herein. Further, the features represented by the blocks in FIG. 3 can be combined in various ways. The system 300 can be implemented using software, hardware, firmware, or a combination thereof.

The system 300 includes a dynamic-customer-product-solution-information-receiver 310 (referred to hereinafter as an “information receiver”), a dynamic-customer-product-solution-data-structure-creator 320 (referred to hereinafter as a “data structure creator”), and a dynamic-customer-product-solution-automatic-determiner 330 (referred to hereinafter as a “solution determiner”). The information receiver 310 is coupled to the data structure creator 320. The data structure creator 320 is coupled to the solution determiner 330.

The information receiver 310 is configured for receiving information describing a plurality of customers' requirements. For example, the information receiver 310 may receive information as depicted in Table 1. The data structure creator 320 is configured for dynamically creating a data structure, such as the data structure depicted in FIG. 1, based on the information. The solution determiner 330 is configured for automatically determining a particular solution based on the data structure and requirements for a particular customer, as will be described in more detail hereinafter.

Two different companies could use a system 300 to dynamically create a data structure for analyzing their own set of customers for example by inputting information that describes their respective customers' requirements. If a particular company's customers' requirements change, the company can generate an entirely different data structure or modify an existing data structure, for example, using different information that describes the new requirements. In another example, the data structure can easily be modified when there are new products or new versions of products. The data structure can be easily modified when the relationships between questions and answers or the interdependencies between products has been improperly determined in the first place. A human can, for example, type information as depicted in Table 1 into a computer.

### A Method for Dynamically Determining Products for a Customer Based on the Customer's Requirements

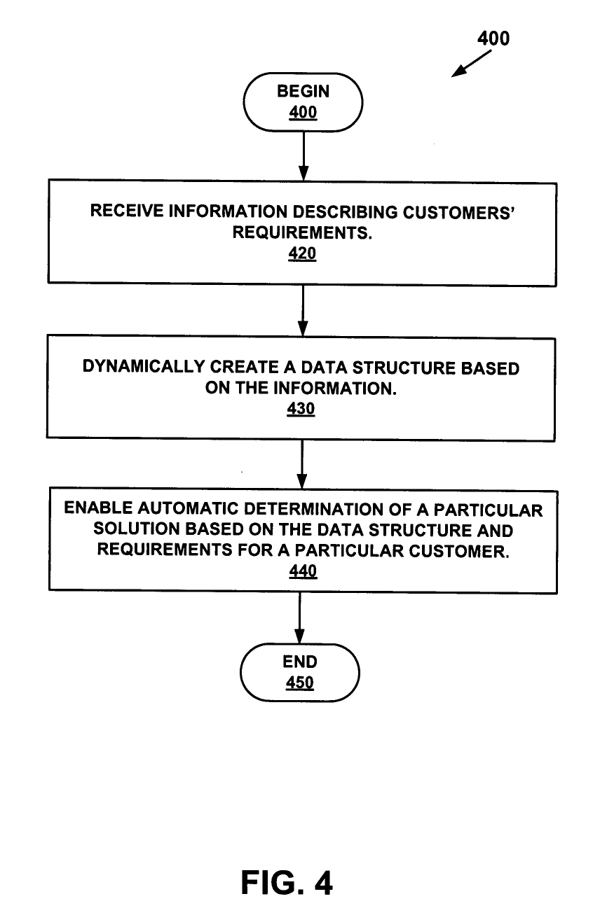

FIG. 4 depicts a flowchart 400 for a method of dynamically determining a product solution for a customer based on the customer's requirements, according to one embodiment. Although specific steps are disclosed in flowchart 400, such steps are exemplary. That is, embodiments of the present invention are well suited to performing various other steps or variations of the steps recited in flowchart 400. It is appreciated that the steps in flowchart 400 may be performed in an order different than presented, and that not all of the steps in-flowchart 400 may be performed.

All of, or a portion of, the embodiments described by flowchart 400 can be implemented using computer-readable and computer-executable instructions which reside, for example, in computer-usable media of a computer system or like device. The computer-usable media can be any kind of memory that instructions can be stored on. Examples of the computer-usable media include but are not limited to a disk, a compact disk (CD), a digital video device (DVD), read only memory (ROM), flash, and so on. As described above, certain processes and steps of the present invention are realized, in one embodiment, as a series of instructions (e.g., software program) that reside within computer readable memory of a computer system and are executed by the of the computer system. When executed, the instructions cause the computer system to implement the functionality of the present invention as described below.

The description of flowchart 400 shall refer to FIGS. 1 and 3 and Table 1.

In step 410, the method begins.

In step 420, information describing customers' requirements is received. For example, the information receiver 210 receives information as depicted in Table 1.

In step 430, a data structure is dynamically created based on the information. The data structure creator 320 dynamically creates a data structure as depicted in FIG. 1 based on information as depicted in Table 1. The data structure includes a plurality of decision trees for types of products. For example decision tree 1 may pertain to operating systems and decision tree 2 may pertain to storage.

The data structure creator 320 can store the data structure, for example, in a database In step 440, automatic determination of a particular solution based on the data structure and requirements for a particular customer is enabled. In this example, the particular solution will include a first product derived from a first decision tree for a first type of product and a second product derived from a second decision tree for a second type of product. The automatic determiner 330 can access the data structure that is stored in the database. The automatic determiner 330 processes the data structure based on answers to questions. For example, assume that the customer is interested in high availability so the decision process starts with decision tree 2. Assume for the sake of illustration that the customer answers A7 to question Q4 and answers A10 to question Q5. Also assume the customer also answers A9 to question Q7 and answers A5 to question Q3. In this case, the solution determined by the automatic determiner 330 includes a first product P5 for a first type of product, such as high availability, and a second product P3 for a second type of product, such as operating systems. As a part of determining to include P3 and P5 in the solution, the automatic determiner 330 used decision tree 1 for one type of product and the decision tree 2 for another type of product.

In step 450, the method ends.

The solution, which in this illustration includes products P3 and P5, or a derivative of the solution can be used by a configurator to generate, for example, a proposal, an invoice, part numbers, or an order, or a combination thereof.

As can be seen, a different set of answers to various questions associated with the data structure, for example, for a different customer would result in a different solution.

Although many of the examples described herein pertained to the computer industry, various embodiments are well suited to other types of businesses. For example, various embodiments may be used in the automotive industry or the construction industry. Although many of the examples described herein pertain to marketing, various embodiments are well suited to other phases of business. For example, a system 300 may be externalized to customers. In another example, a system 300 may be used by software engineers and electrical engineers as a part of determining whether changes to one type of product may affect another type of product.

Various embodiments have been described in various combinations. However, any two or more embodiments may be combined. Further, any embodiment may be used separately from other embodiments.

Embodiments of the present invention are thus described. While the present invention has been described in particular embodiments, it should be appreciated that the present invention should not be construed as limited by such embodiments, but rather construed according to the following claims.

What is claimed is:

1. A method of dynamically determining a product solution for a customer based on the customer's requirements, the method comprising:
receiving information describing customers' requirements;
dynamically creating a data structure based on the information, wherein the data structure includes a plurality of decision trees for types of products; and
enabling automatic determination of a particular solution based on the data structure and requirements for a particular customer wherein the automatic determination uses a first decision tree for a first type of product and a second decision tree for a second type of product to determine what products to associate with the particular solution.

2. The method as recited by claim 1, further comprising:
dynamically modifying the data structure based on different information describing new customer requirements.

3. The method as recited by claim 1, wherein the receiving of the information describing the customers' requirements further comprises:
receiving information that includes relationships between questions and answers to determine the customers' requirements.

4. The method as recited by claim 3, wherein the enabling of the automatic determination of the particular solution further comprises:
traversing the data structure based on one or more of the answers to one or more of the questions.

5. The method as recited by claim 1, wherein a type of product is selected from a group consisting of operating system, storage, printer, high availability, virtualization, and manageability.

6. The method as recited by claim 1, wherein the method further comprises:
transmitting the solution to a configurator to determine how to configure at least a part of the particular customer's computer environment.

7. A system for dynamically determining a product solution for a customer based on the customer's requirements, the system comprising:
dynamic-customer-product-solution-information-receiver configured for receiving information describing a plurality of customers' requirements;
dynamic-customer-product-solution-data-structure-creator configured for dynamically creating a data structure based on the information, wherein the data structure includes a plurality of decision trees for types of products; and
dynamic-customer-product-solution-automatic-determiner configured for automatically determining a particular solution based on the data structure and requirements for a particular customer wherein the wherein the dynamic-customer-product-solution-automatic-determiner uses a first decision tree for a first type of product and a second decision tree for a second type of product to determine what products to associate with the particular solution.

8. The system of claim 7, wherein the dynamic-customer-product-solution-data-structure-creator creates a different data structure based on different information that describes different customer requirements.

9. The system of claim 7, wherein the particular solution includes at least a minimum of products to satisfy the particular customer's requirements.

10. The system of claim 7, wherein a product is a product bundle.

11. The system of claim 7, wherein the system transmits the solution to a configurator to determine how to configure at least a part of the particular customer's computer environment.

12. The system of claim 11, wherein the configurator uses the solution to generate a list of part numbers.

13. The system of claim 11, wherein the system stores the data structure in a database.

14. The system of claim 7, wherein the dynamic-customer-product-solution-automatic-determiner traverses the data structure based on one or more of the particular customer's answers to one or more of questions to automatically determine the particular solution.

15. A computer-usable medium having computer-readable program code embodied therein for causing a computer system to perform a method of dynamically determining a product solution for a customer based on the customer's requirements, the method comprising:
receiving information that enables automatically determining solutions based on customers' requirements;
dynamically creating a data structure based on the information, wherein the data structure includes a plurality of decision trees for types of products and wherein automatic determination of a particular solution is enabled by traversing the data structure based on answers to questions to determine requirements for a particular customer.

16. The computer-usable medium of claim 15, wherein the computer-readable program code embodied therein causes a computer system to perform the method, and wherein the method further comprises:
using a first decision tree for a first type of product and a second decision tree for a second type of product to automatically determine what products to associate with the particular solution.

17. The computer-usable medium of claim 15, wherein the computer-readable program code embodied therein causes a computer system to perform the method, and wherein the method further comprises:
dynamically modifying the data structure based on different information describing new customer requirements.

18. The computer-usable medium of claim 15, wherein the computer-readable program code embodied therein causes a computer system to perform the method, and wherein the receiving of the information that enables automatically determining the customers' requirements further comprises:
receiving information that includes relationships between questions and answers to determine the customers' requirements.

19. The computer-usable medium of claim 18, wherein the computer-readable program code embodied therein causes a computer system to perform the method, and wherein the method further comprises:
traversing the data structure based on one or more of the answers for the particular customer to one or more of the questions to determine the requirements for the particular customer.

20. The computer-usable medium of claim 15, wherein the computer-readable program code embodied therein causes a computer system to perform the method, and wherein the method further comprises:
transmitting the solution to a configurator to determine how to configure at least a part of the particular customer's computer environment.
